(19) United States
(12) Patent Application Publication
(10) Pub. No.: US 2026/0240630 A1
(43) Pub. Date: Aug. 20, 2026

(54) Dental Implants and Uses Thereof

(71) Applicant: University of Connecticut, Farmington, CT (US)

(72) Inventors: Martin Freilich, West Hartford, CT (US); Vlad Ilies, Glastonbury, CT (US); Eli Freilich, West Hartford, CT (US); Horea Ilies, Glastonbury, CT (US)

(73) Assignee: University of Connecticut, Farmington, CT (US)

(21) Appl. No.: 19/543,420

(22) Filed: Feb. 18, 2026

Related U.S. Application Data
(60) Provisional application No. 63/759,623, filed on Feb. 18, 2025.

(51) Int. Cl. A61C 8/00

(52) U.S. Cl. CPC A61C 8/0093; A61C 8/0016; A61C 8/0074

(57) ABSTRACT

An artificial salivary gland is provided that may include a prosthetic crown, an implant fixture, and a valve. The prosthetic crown may include a crown bottom portion and the implant fixture may include a top portion, a bottom portion, a fixture inlet, and a fixture outlet. Further, the implant fixture may define an internal bore, and the top portion of the implant fixture may be disposed proximate the crown bottom portion. The valve may be disposed at least partially within the internal bore of the implant fixture. Further, the valve may include a valve inlet and a valve outlet. The fixture inlet may be in fluid communication with the valve inlet, the valve inlet may be in fluid communication with the valve outlet, and the valve outlet may be in fluid communication with the fixture outlet.

### RELATED APPLICATIONS

This application claims the benefit of U.S. Provisional Patent Application No. 63/759,623, filed on Feb. 18, 2025, the entirety of which is hereby incorporated by reference.

### TECHNICAL FIELD

The present disclosure relates to dental implant systems such as salivary gland devices or assemblies and, more particularly, to artificial salivary pump/gland devices or assemblies and related methods of use.

### BACKGROUND

As many as 20 million individuals in the U.S. alone cannot make sufficient saliva for normal function and comfort, a condition called xerostomia. The vast majority of these (about 16 million) have xerostomia as a side-effect of prescription medications, another 4 million due to Sjögren's Syndrome and approximately 30,000 become xerostomic each year secondary to head and neck radiation for cancer. Aside from discomfort and pain, related to chronically dry oral mucosa, xerostomia often leads to caries and Candidiasis due to the lack of salivary functions related to enzymatic activity and buffering. Numerous lubricating and saliva substitute products have proven to be ineffective in bringing relief.

Average whole saliva flow in healthy individuals is about 1.0 L to 1.5 L per day (0.7 to 1.0 ml/min). Xerostomia (dry mouth) due to hyposalivation is commonly defined as stimulated flow of ≤0.2 ml/minute, and is most commonly associated with Sjögren's Syndrome and post head/neck radiation cancer treatment. Discomfort and pain are related to chronically dry oral mucosa, while increased disease processes are related to the lack of salivary functions which are chemistry dependent.

Dry mouth is a common problem with a range of causes. The symptom may be due to a reduction in the quantity of saliva produced, or a change in the composition of saliva, but a feeling of dry mouth may also be present in people with normal saliva production. Radiotherapy or chemotherapy for head and neck cancers, and diseases such as Sjögren's Syndrome, may result in reduced saliva production. Many commonly prescribed medications are associated with a feeling of dry mouth, despite normal saliva production. As well as difficulty in speaking, chewing and swallowing, prolonged dry mouth may result in increased risk of tooth decay and reduced quality of life.

Current treatments for xerostomia involve both symptomatic relief and addressing underlying causes. Symptomatic management may include the use of saliva substitutes, which are products designed to mimic the natural properties of saliva. These substitutes often contain lubricants, electrolytes, and enzymes to provide moisture and comfort to oral tissues. Patients may also use saliva stimulants, such as sugar-free chewing gums or lozenges that contain xylitol, which may promote natural saliva production. However, these substitutes often lack the complexities and enzymes found in natural saliva, potentially resulting in incomplete or temporary relief. Additionally, the effectiveness of saliva stimulants may vary among individuals and might not be adequate for patients with severely compromised salivary gland function.

Pharmacological interventions can be employed to stimulate salivary flow. Medications such as pilocarpine and cevimeline are cholinergic agonists that act to enhance salivary gland function. These drugs may be prescribed for patients where xerostomia is related to conditions like Sjögren's syndrome or as a side effect of certain treatments like radiation therapy or medication. However, the effectiveness of these drugs is inconsistent and can vary based on the underlying cause of xerostomia. Moreover, these medications are often accompanied by side effects which necessitates careful medical supervision.

Accordingly, an improved treatment for xerostomia is needed.

### SUMMARY

In one aspect, an artificial salivary gland for providing fluid to an inside of a subject's mouth is provided. In some embodiments, the artificial salivary gland may include a prosthetic crown, an implant fixture, and a valve. In some embodiments, the prosthetic crown may include a crown bottom portion. In some embodiments, the implant fixture may include a top portion, a bottom portion, a fixture inlet, and a fixture outlet. Further, the implant fixture may define an internal bore, and the top portion of the implant fixture may be disposed proximate the crown bottom portion. In some embodiments, the valve may be disposed at least partially within the internal bore of the implant fixture. Further, the valve may include a valve inlet and a valve outlet. In some embodiments, the fixture inlet may be in fluid communication with the valve inlet, the valve inlet may be in fluid communication with the valve outlet, and the valve outlet may be in fluid communication with the fixture outlet.

In another aspect, a method for pumping fluid is provided. In some embodiments, the method may include providing an artificial salivary gland comprising a prosthetic crown defining a crown orifice, a crown insert disposed at least partially within a crown orifice, and a valve. Some embodiments may include depressing the crown insert in an axial direction. Some embodiments may include receiving, through a valve inlet of the valve, the fluid. And in some embodiments, the method may include flowing the fluid through a valve outlet of the valve.

Various refinements of the features noted in relation to the above-mentioned aspects exist. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF THE FIGURES

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views:

FIG. 1A depicts a side-by-side image of a natural tooth and a typical dental implant.

FIG. 1B depicts a side-by-side, cross-sectional image of a natural tooth and a typical dental implant, installed within the jawbone of a subject.

FIG. 1C depicts a cutaway of a jawbone in which dental implant has been installed.

FIG. 2A depicts an artificial salivary gland according to embodiments disclosed herein.

FIG. 2B depicts cross-section 2-2′ as taken in FIG. 2A, and provides greater details on the internal construction of the artificial salivary gland depicted in FIG. 2A.

FIGS. 3A and 3B depict a cross section of a poppet valve according to embodiments disclosed herein.

FIGS. 4A and 4B depict a valve shaft and flexible disk for use in a poppet valve according to embodiments disclosed herein.

FIGS. 5A and 5B depict a cross-sectional view of an artificial salivary gland which utilizes a ball check valve, according to embodiments disclosed herein.

FIGS. 6A and 6B depict a cross-sectional view of a displacement amplifier of an artificial salivary gland according to embodiment disclosed herein.

FIG. 7 depicts a cross-sectional view of a check valve which utilizes a compliant mechanism, according to embodiments disclosed herein.

FIG. 8 is a flow chart depicting a method for pumping fluid.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

For the purposes of this disclosure, the terms “coronal” and “apical” are used to describe relative positions or directions along the longitudinal axis A of the dental implant and/or its components. The term “coronal” (or “coronally”) refers to a direction toward the crown of a tooth or the part of the implant that is distal to the patient's jawbone once installed. Conversely, the term “apical” (or “apically”) refers to a direction toward the root tip or apex of a tooth, or the portion of the implant that is proximal to the patient's jawbone and intended for deep anchoring within the bone. Accordingly, the coronal end of the implant typically refers to the “top” or “upper” portion that interfaces with an abutment or prosthetic, while the apical end refers to the “bottom” or “lower” portion that first enters the osteotomy site during placement.

Dental implants serve as a prosthetic solution for replacing missing or damaged teeth. They aim to mimic the function and appearance of natural teeth by providing a stable foundation for dental prosthetics such as crowns. The primary purpose of a dental implant is to restore oral functionality, improve aesthetics, and maintain the structural integrity of the jawbone. Implants are widely regarded as a reliable and long-term solution for tooth loss, particularly because they are anchored directly into the jawbone, providing stability similar to that of a natural tooth root.

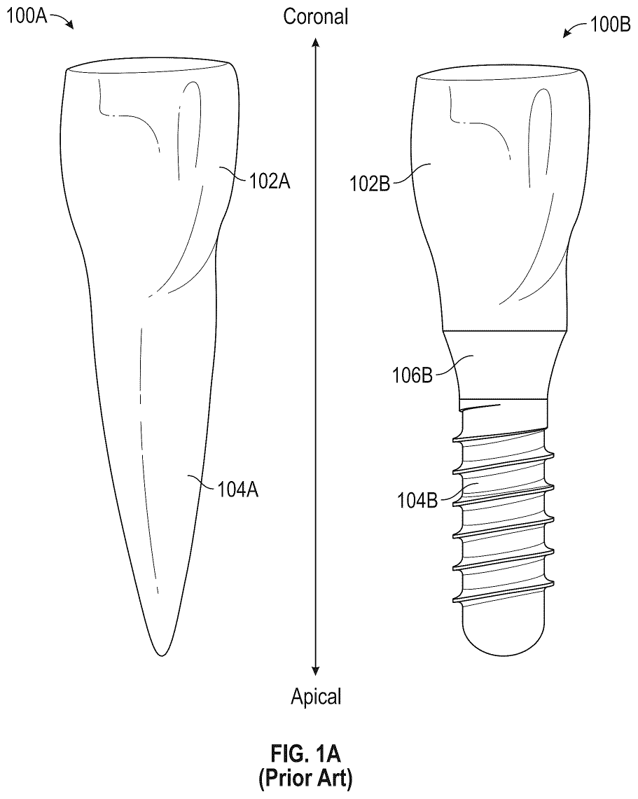

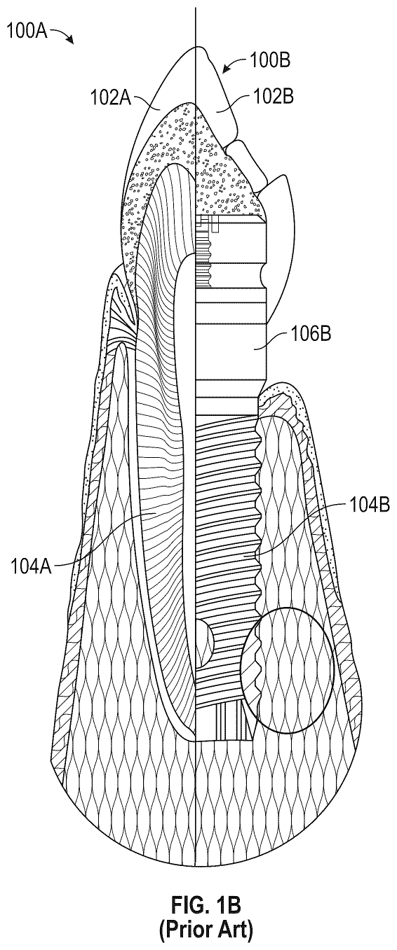

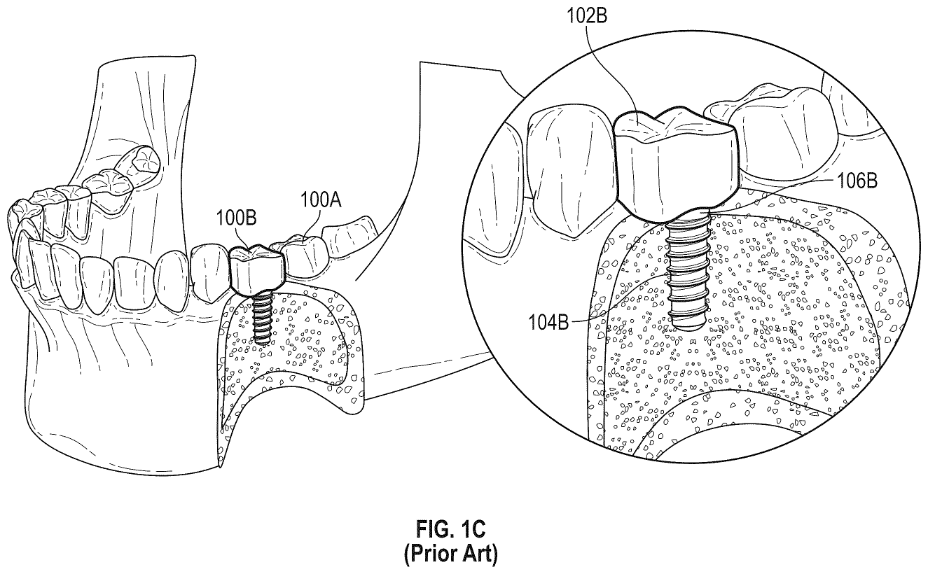

FIG. 1A depicts a side-by-side image of a natural tooth 100A and a typical dental implant 100B. FIG. 1B depicts a side-by-side, cross-sectional image of a natural tooth 100A and a typical dental implant 100B, installed within the jawbone of a subject. FIG. 1C depicts a cutaway of a jawbone in which dental implant 100B has been installed.

Natural tooth 100A may include a natural crown 102A and a natural root 104A. Dental implant 100B comprises an prosthetic crown 102B, implant fixture 104B, and an abutment 106B. The implant fixture 104B-often shaped like a cylindrical or tapered screw—is surgically inserted into the subject's jawbone. The abutment 106B serves as a connector between the implant fixture 104B and the prosthetic crown 102B, and may be a part of, or integral with, implant fixture 104B, or may be distinct and separate from implant fixture 104B.

Dental implants are commonly manufactured from biocompatible materials, with titanium and its alloys being prevalent due to their strength and ability to osseointegrate—that is, structurally and functionally merge—with the subject's jawbone. Some implants may also use zirconia, known for its aesthetic qualities and compatibility with human tissue. Surface treatments are often applied to these materials to enhance integration and longevity.

The installation of a dental implant 100B typically involves several stages. The first surgical step involves placing the implant fixture 104B into the jawbone. Once the dental implant 100B is securely positioned, a healing period—which may vary from several weeks to months—allows for osseointegration.

Following osseointegration, the next phase involves attaching the abutment 106B to the implant fixture 104B. Once the surrounding gum tissue has healed around the abutment 106B, an impression is taken to fabricate the prosthetic crown 102B. The prosthetic crown 102B is then attached to the abutment 106B, completing the implant process.

In exemplary embodiments, an artificial salivary gland (“ASG”) is integrated within a dental implant may provide a number of significant improvements over existing therapies for treating xerostomia. First, integrating an ASG within a dental implant may allow dental practitioners to utilize existing techniques and/or devices associated with dental implants. Second, compared to over-the-counter rinses or prescription saliva stimulants, the ASG(s) disclosed herein may continuously provide a saliva substitute via occlusal forces, minimizing the need for regular dosing or application. Third, by actively pumping interstitial fluid on demand during normal biting, the ASG(s) disclosed herein offers more consistent relief than passive aids such as mouth sprays, which only provide temporary moisture. Fourth, unlike existing implantable ducts or stents, the built-in filters disclosed herein remove cells and macromolecules, ensuring a cleaner fluid supply and reducing the risk of blockages. Fifth, the cyclical pumping action requires no batteries or external power, potentially lowering ongoing expenses compared to continuous-use mechanical pumps (e.g., external infusion devices) and repeated consumable purchases. And sixth, in contrast to surgical salivary gland transfers, the ASG(s) disclosed herein uses natural occlusal forces below 50N, reducing post-operative complexities and providing a less invasive method for alleviating xerostomia.

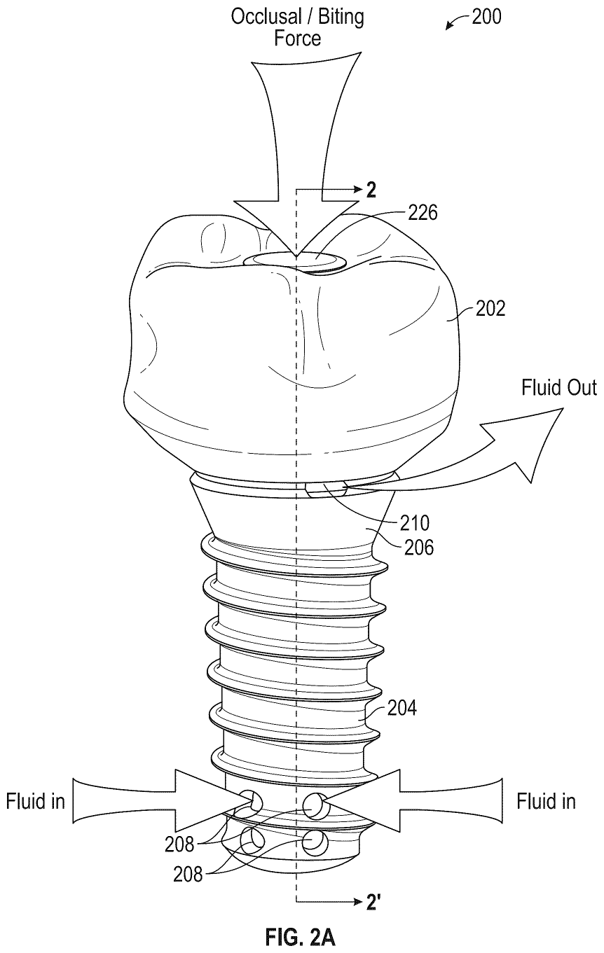

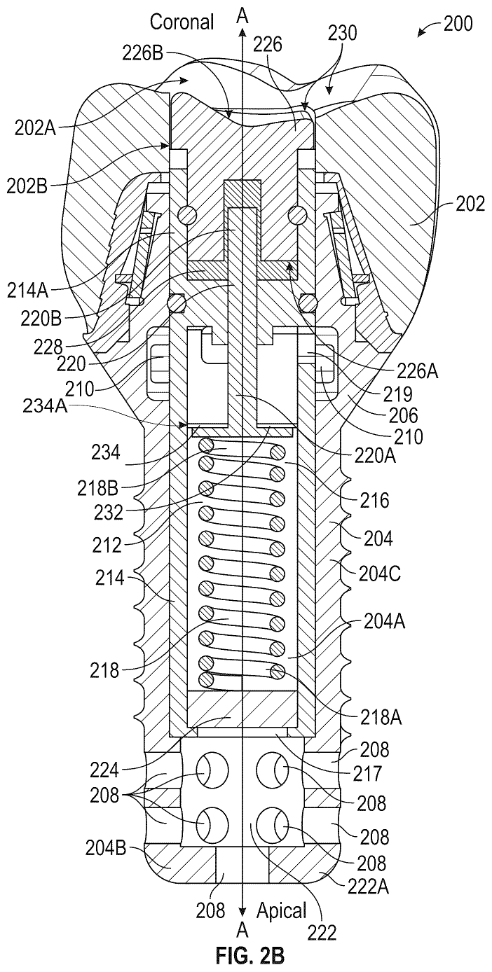

FIG. 2A depicts an ASG 200 according to embodiments disclosed herein. As can be seen, ASG 200 may include a prosthetic crown 202, an implant fixture 204, and abutment 206. The abutment 206 serves as a connector between the implant fixture 204 and the prosthetic crown 202. Hereinafter, abutment 206 will be referred to and considered as a part of, or integral with, implant fixture 204. However, one having ordinary skill in the art will understand that abutment 206 may be distinct and separate from implant fixture 204. Additionally, FIG. 2A depicts crown insert 226, fixture inlets 208, and fixture outlet 210, all of which will be described in greater detail below.

FIG. 2B depicts cross-section 2-2′ as taken in FIG. 2A, and provides greater details on the internal construction of ASG 200. As seen in FIG. 2B, implant fixture 204 may have a bore 204A which runs at least partially through implant fixture 204. Implant fixture 204 and bore 204A may both be axially aligned with axis A, which is also axially aligned with ASG 200 as a whole, abutment 206, and prosthetic crown 202. In some embodiments, prosthetic crown 202 may include a crown surface 202A and a crown orifice 202B. Crown orifice 202B may be axially aligned with axis A. In some embodiments, implant fixture 204 may include at least one fixture inlet 208 and at least one fixture outlet 210. In some embodiments, implant fixture 204 may include a fixture chamber 222 located at a bottom portion 204B of implant fixture 204. In some embodiments, the fixture inlet(s) 208 may be formed in a sidewall 222A of fixture chamber 222. Furthermore, fixture outlet(s) 210 may be formed in sidewall 204C of implant fixture 204.

Implant fixture 204 may be manufactured from biocompatible materials such as titanium and its alloys, which may be utilized due to their strength and ability to osseointegrate with the jawbone. In some embodiments, the titanium's surface may be subjected to various treatments to enhance integration and longevity, such as sandblasting or acid etching, which create a rough texture that may promote bone attachment. Other embodiments may employ zirconia, a ceramic material known for its aesthetic qualities and high compatibility with human tissue. In some embodiments, implant fixture 204 may have the form of a cylindrical or tapered screw to improve its stability and osseointegration potential; as seen in FIGS. 2A and 2B, implant fixture 204 may include threaded sidewall 204C. Additionally, abutment 206, which connects the implant fixture 204 to the prosthetic crown 202, may be constructed from the same biocompatible materials, with its shape and design optimized to support the final restoration and ensure a secure connection.

ASG 200 may further include valve 212, which may be a one-way valve in some embodiments. Valve 212 may be axially aligned with axis A and may be positioned at least partially within bore 204A of implant fixture 204. In some embodiments, ASG 200 may be modular such that valve 212 or any other component can be replaced for repair or for regular maintenance. In some embodiments, valve 212 may be a check valve. More specifically, and as shown in FIG. 2B, valve 212 may be a poppet check valve (hereinafter, “poppet valve”). However, one having ordinary skill in the art will understand that valve 212 may be any other suitable type of check valve including, but not limited to, a ball check valve, a lift check valve, or a duckbill valve. Valve 212 may include valve case 214, which may have a circular profile which is sized and shaped to fit securely within bore 204A. Valve case 214 may further include a top portion 214A which may be shaped to receive crown insert 226, as will be described in further detail below. Valve 212 may also include valve chamber 216 in which coil spring 218 may be enclosed, and a valve inlet 217 and a valve outlet 219-both of which may be in fluid communication with valve chamber 216. Furthermore, valve inlet 217 may be in fluid communication with fixture inlet 208, and valve outlet 219 may be in fluid communication with fixture outlet 210. In this way, fluid may flow into fixture inlet 208, through valve inlet 217 and into valve chamber 216, through valve outlet 219, and out of fixture outlet 210. In this way, fixture outlet 210 may be in fluid communication with an oral cavity of the subject (not pictured).

Coil spring 218 may include a spring bottom end 218A and a spring top end 218B. Valve 212 may also include valve shaft 220, which may be at least partially disposed within valve chamber 216. Valve shaft 220 may include shaft bottom end 220A and shaft top end 220B. Valve shaft 220 may further include a valve seat 232 and a flexible disk 234 which is located on top of valve seat 232. In some embodiments, valve seat 232 may have a diameter which is slightly smaller than a diameter of valve chamber 216; in some embodiments, flexible disk 234 may have a diameter which may be substantially equal to or slightly larger than the diameter of valve chamber 216. In this way, the edge 234A of flexible disk 234 may contact inner sidewall 214C of valve case 214 to form a fluid seal.

In some embodiments, shaft bottom end 220A may be positioned adjacent to and on top of spring top end 218B such that translating valve shaft 220 in the direction of axis A that is, in an apical direction—may cause coil spring 218 to compress; subsequently releasing valve shaft 220 may cause coil spring 218 to expand, thereby causing valve shaft 220 to translate in an opposite direction along axis A—that is, in a coronal direction. In some embodiments, valve 212 may have a filter 224.

As is further seen in FIG. 2B, crown insert 226 may be disposed at least partially within each of crown orifice 202B and top portion 214A of valve case 214. In some embodiments, crown insert 226 may be axially aligned with axis A. In some embodiments, a gap formed between a bottom surface 226A of crown insert 226 and bottom surface 214B of top portion 214A may define an amplification chamber 228, which may be filled with an incompressible fluid, and which will be described in further detail below. In some embodiments, crown insert 226 may function as a button, wherein (1) depressing crown insert 226 in the direction of axis A causes valve shaft 220 to translate, thereby causing coil spring 218 to compress, and (2) crown insert 226 causes causing coil spring 218 to expand to its neutral state, thereby causing valve shaft 220 to translate in the opposite direction of axis A. The depressing effect of crown insert 226 may be amplified by the inclusion of a displacement amplifier within ASG 200, which will be described in further detail below.

As can be seen in FIG. 2B, the crown surface 202A of prosthetic crown 202 and the insert surface 226B of crown insert 226 may jointly and continuously form an occlusal surface 230. In some embodiments, occlusal surface 230 may have any contour and/or shape, including flat, domed, concave, etc. In some embodiments, occlusal surface 230 may mimic the contour and/or shape of an occlusal surface—that is, the biting surface—of a natural tooth. In some embodiments, when coil spring 218 is in its neutral state, insert surface 226B may be slightly raised above crown surface 202A such that continuous occlusal surface 230 is formed when the subject bites down on ASG 200, thus depressing crown insert 226 and insert surface 226B. In other embodiments, when coil spring 218 is in its neutral state, insert surface 226B may be even with crown surface 202A such that continuous occlusal surface 230 is formed. In this way, insert surface 226B may be depressed below crown surface 202A when the subject bites down on ASG 200. In some embodiments, activating valve 212—that is, biting down on crown insert 226—may draw interstitial fluid from the subject's jawbone, and deliver to their oral cavity approximately 0.01 mL of interstitial fluid. In other embodiments, activating valve 212 may deliver to the subject's oral cavity approximately 0.02 mL, 0.03 mL, 0.04 mL, 0.05 mL, 0.06 mL, 0.07 mL, 0.08 mL, 0.09 mL, 0.10 mL, or any other suitable volume of interstitial fluid.

Prosthetic crown 202 and crown insert 226 may be manufactured utilizing a range of biocompatible materials to ensure compatibility with the surrounding oral tissues and durability under functional stresses. In some embodiments, prosthetic crown 202 and crown insert 226 may be manufactured from ceramics, such as zirconia or porcelain, which offer favorable aesthetic characteristics due to their ability to mimic the translucency and color of natural teeth. Alternatively, metal alloys, such as gold or silver-palladium, may be employed for their strength and longevity, although these materials may be more suitable for posterior teeth where aesthetic considerations are secondary. Hybrid materials, combining ceramics with metal substructures, may also provide a balance of aesthetics and strength. In some embodiments, prosthetic crown 202 and crown insert 226 may be manufactured utilizing precise computer-aided design and manufacturing (CAD/CAM) techniques to accurately replicate the natural tooth's shape and fit the individual patient's dental anatomy. This ensures that prosthetic crown 202 and crown insert 226 maintain proper occlusion and integration with adjacent teeth, contributing to the overall functionality of the dental restoration.

Some embodiments of ASG 200 may include filter 224. As shown in FIG. 2B, filter 224 may be located within valve chamber 216 and downstream of—that is, located coronally relative to—valve inlet 217; however, filter 224 may be located in a number of other positions within ASG 200. In some embodiments, filter 224 may be located upstream of fixture inlet 208; in some embodiments, filter 224 may be located between fixture inlet 208 and valve inlet 217; in some embodiments, filter 224 may be located in front of valve outlet 219; in some embodiments, filter 224 may be located between valve outlet 219 and fixture outlet 210; and in some embodiments, filter 224 may be located downstream of fixture outlet 210.

Filter 224 may be configured to process interstitial fluid to produce a fluid with characteristics suitable for use as artificial saliva. In some embodiments, filter 224 may include a multi-layer filtration system designed to selectively remove impurities, cells, marrow cells, macromolecules, and other unwanted components from the interstitial fluid. The layers of the filtration system may be composed of various materials, such as polypropylene membranes, activated carbon, and ion-exchange resins. Each layer may be engineered to target specific contaminants, ensuring the resulting fluid retains beneficial electrolytes and proteins that contribute to the desired viscosity and lubricating properties reminiscent of natural saliva. In addition, the filter 224 may be designed to incorporate a biomimetic component that further enhances the fluid's saliva-like properties. This component may include enzyme integration to mimic the enzymatic activity inherent in natural saliva.

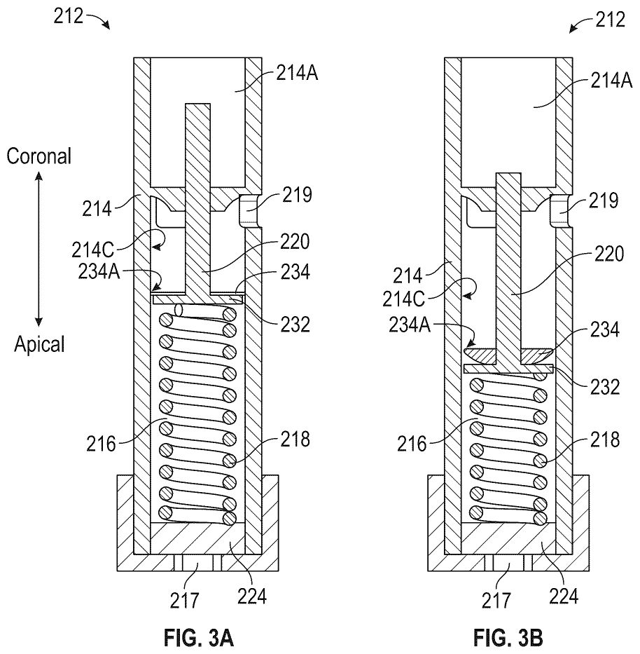

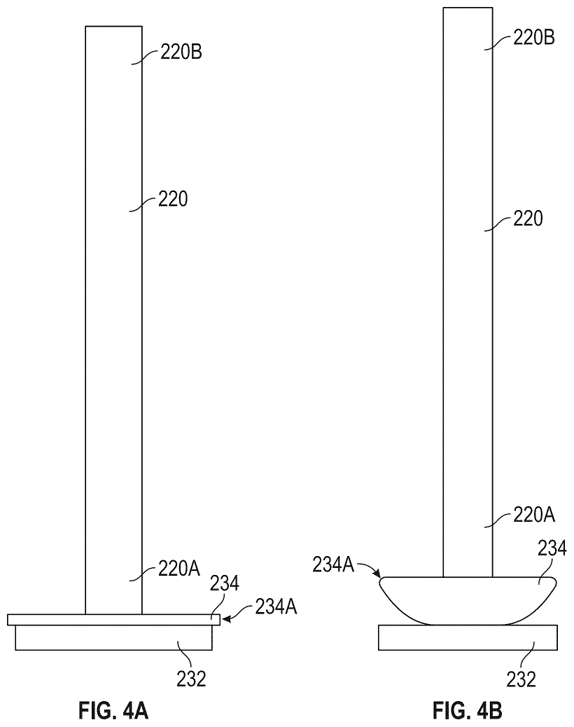

FIGS. 3A, 3B, 4A, and 4B depict the functionality of valve 212 which, as stated above may be a poppet valve. As can be seen, FIG. 3A depicts valve 212 in a closed condition and FIG. 3B depicts valve 212 in an open condition. When valve 212 is in the closed condition, fluid may flow through valve inlet 217 and into valve chamber 216. When a subject bites down on ASG 200, the crown insert 226 may be depressed, causing valve 212 to transition to the open condition in the following manner. Upon depressing crown insert 226, valve shaft 220 is also depressed such that coil spring 218 is compressed. As valve shaft 220 translates apically in the direction of axis A, friction at the interface of flexible disk edge 234A and inner sidewall 214C of valve case 214 may cause flexible disk 234 to invert and/or upturn as seen in FIG. 4B. In this way, the diameter of flexible disk 234 is reduced such that the seal between flexible disk edge 234A and inner sidewall 214C is broken. Because this seal is broken in the open condition, fluid may flow past flexible disk 234, through valve chamber 216, and out valve outlet 219. When the subject opens their jaw-thereby releasing crown insert 226-coil spring 218 returns to its neutral position, thereby translating valve shaft 220 coronally. As valve shaft 220 translates coronally, valve seat 232 presses against flexible disk 234, thereby causing it to flatten and restore the seal with inner sidewall 214C. In this way, fluid is no longer able to bypass flexible disk 234 such that valve 212 is now in the closed condition.

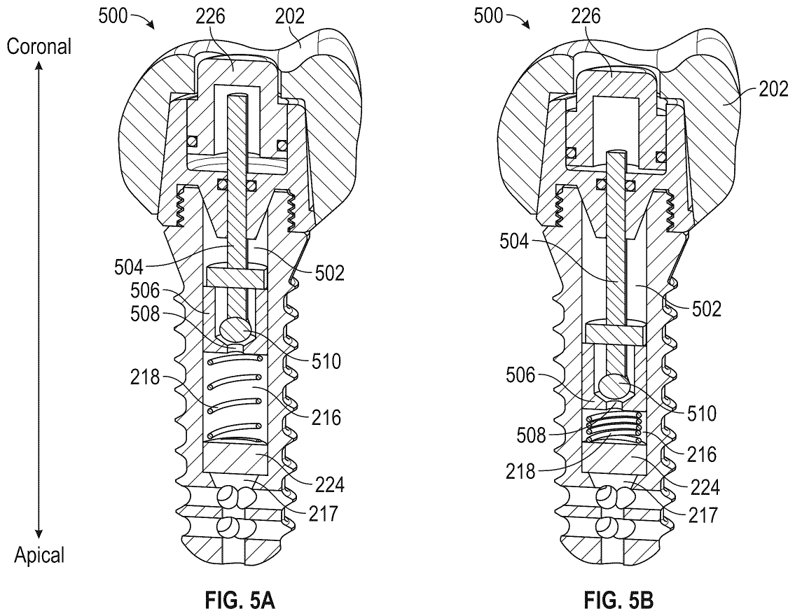

FIGS. 5A and 5B depict ASG 500, which is substantially similar to ASG 200 but for the inclusion of valve 502 instead of valve 212; in this way, any of the teachings disclosed herein (notwithstanding the inclusion of valve 212) may equally apply. Unlike valve 212, which is a poppet check valve, valve 502 is a ball check valve. Valve 502 may include valve shaft 504, valve seat 506 which includes orifice 508, and ball 510.

As can be seen, FIG. 5A depicts valve 502 in a closed condition and FIG. 5B depicts valve 502 in an open condition. When valve 502 is in the closed condition, fluid may flow through valve inlet 217 and into valve chamber 216. When a subject bites down on ASG 200, the crown insert 226 may be depressed, causing valve 502 to transition to the open condition in the following manner. When valve 502 is in the closed condition, ball 510 may be firmly seated against orifice 508 such that a seal is formed and fluid cannot pass through orifice 508. Upon depressing crown insert 226, valve shaft 504 is also depressed such that coil spring 218 is compressed. As valve shaft 504 translates apically in the direction of axis A, ball 510 is translated away from an orifice 508 such that the seal is broken and fluid may flow through orifice 508. Because this seal is broken in the open condition, fluid may flow past orifice 508 and ball 510, through valve chamber 216, and out valve outlet 219. When the subject opens their jaw-thereby releasing crown insert 226-coil spring 218 returns to its neutral position, thereby translating valve shaft 220 coronally. As valve shaft 504 translates coronally, so does ball 510, thereby causing it to seat against orifice 508 and restore the seal. In this way, fluid is no longer able to bypass ball 510 such that valve 502 is now in the closed condition.

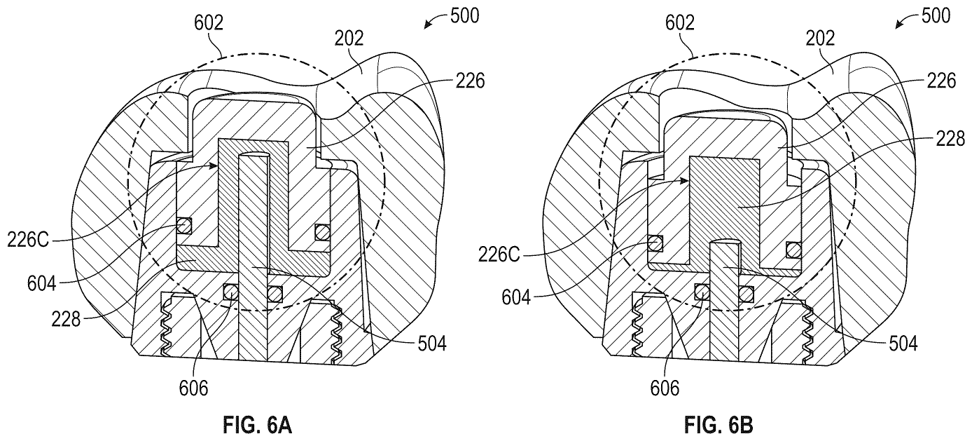

Reference will now be made to FIGS. 6A and 6B, which depict a section view of ASG 500; one having ordinary skill in the art will understand that the following teachings will equally apply to ASG 200. FIGS. 6A and 6B depict ASG 500 in (A) the closed condition (FIG. 6A) with crown insert 226 in a neutral position, and (B) the open condition (FIG. 6B) with crown insert 226 in a depressed position. In some embodiments, ASG 500 may include a displacement amplifier 602. In some embodiments, displacement amplifier 602 may be comprised of crown insert 226, valve shaft 504, amplification chamber 228, and an incompressible fluid disposed within amplification chamber 228 (not labeled). Furthermore, some embodiments of ASG 500 may include seal 604 and seal 606 to prevent the incompressible fluid from leaking from amplification chamber 228. As shown in FIGS. 6A and 6B, seals 604, 606 may be O-rings, although one having ordinary skill in the art will understand that any other suitable sealing means may be used.

Displacement amplifier 602 may serve to amplify a distance which valve shaft 220 translates in the apical direction relative to a translation distance of crown insert 226. For example, in some embodiments, crown insert 226 may only be capable of being depressed a short distance in the apical direction, e.g. less than 0.5 mm or less than 1.0 mm. This small distance may be limited by physical constraints of the subject's oral cavity, and/or for comfort-related reasons. Nevertheless, such a relatively small depression of the crown insert 226 may be capable of depressing valve shaft 220 at least 1.5 mm, 2.0 mm, 2.5 mm, 3.0 mm, 3.5 mm, or any other suitable distance for delivering a therapeutic volume of interstitial fluid (that is, approximately 0.01-0.02 mLs in some embodiments).

In some embodiments, displacement amplifier 602 may operate as follows. Crown insert 226 may include an inner bore 226C, in which shaft top end 220B is disposed. The diameter of inner bore 226C may be greater than the diameter of shaft top end 220B.

Displacement chamber 228 may be filled with an incompressible fluid, including but not limited to mineral-based hydraulic oils, silicon oils, synthetic esters and polyalphaliolefins, water-glycol mixtures, or high-consistency gels. As crown insert 226 is depressed, all fluid within amplification chamber 228 is forced into inner bore 226C. This depressing movement displaces a volume of fluid equal to the surface area of the bottom surface 226A of crown insert 226 multiplied by the distance crown insert 226 travels. To accommodate this “new” volume, the fluid within amplification chamber 228 pushes against the valve shaft 220. Because the valve shaft 220 has a much smaller cross-sectional area than bottom surface 226A, the fluid must push valve shaft 220 apically much further than the crown insert 226 moved to maintain the same total volume within inner bore 226C. As a result, depressing crown insert 226 several tenths of a millimeter may result in a travel distance of several millimeters for valve shaft 220.

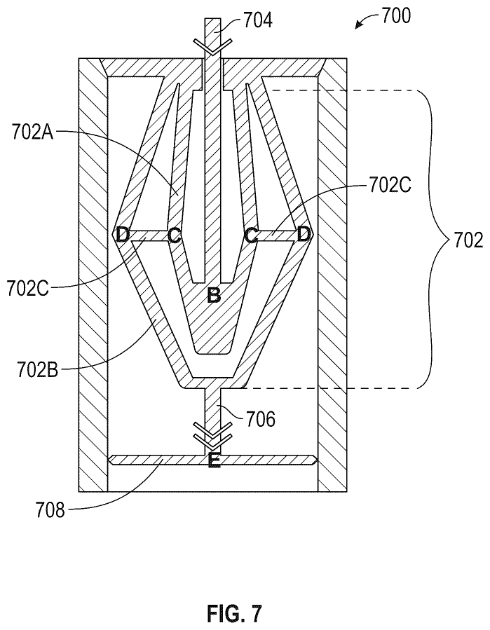

Reference will now be made to FIG. 7, which depicts a cross-sectional view of valve 700, which includes compliant—that is, elastically deformable-mechanism 702. Valve 700 differs from valves 212, 502 in that it integrates a mechanical displacement amplifier directly therein, thereby eliminating the need for displacement amplifier 602. In other words, valve 700 may directly replace (A) valve 212 and displacement amplifier 602 in ASG 200, or (B) valve 502 and displacement amplifier 602 in ASG 500. Stated yet another way, an ASG incorporating valve 700 may not need to utilize any incompressible fluid. By eliminating discrete components like springs, pistons, and precision seals, the compliant mechanism 702 may reduce mechanical complexity and improve long-term reliability by removing common failure modes. Compliant mechanism 702 may further reduce manufacturing complexity and costs by reducing the number of components needed to manufacture valve 700.

In some embodiments, compliant mechanism 702 may comprise a double-nested rhombus compliant mechanism which may comprise two or more layers of interconnected rhombus-shaped elements designed to flex elastically. This configuration enables compliant mechanism 702 to amplify input displacements while maintaining structural integrity. The compliant mechanism 702 may be fabricated from materials such as spring steel or polymers that can endure repeated flexural motion without fatigue.

In operation, an occlusal force may be applied to crown insert 226, which may translate down to valve input shaft 704. This force may in turn cause the rhombus elements 702A, 702B to deform, creating a larger translation at the valve output shaft 706 than the translation at valve input shaft 704. This amplified displacement may be harnessed to actuate the valve 700, thus allowing for fine-tuned control over fluid flow through the valve 700. The geometric arrangement of the rhombus elements 702A, 702B provides inherent flexibility.

More specifically, compliant mechanism 702 may function as follows. Upon receiving an apical force, valve input shaft 704 may translate apically such that point B also translates apically by the same distance. The stretching of rhombus links 706C in the apical direction may be assumed to be zero or negligible. However, this apical displacement may drive points C inward by an amount which is determined by the precise dimensions of compliant mechanism 702. That inward motion of rhombus links 702C, in turn, pulls points D inward, thereby forcing point E, valve output shaft 706, and valve seat 708 to move apically by some amount which is greater than the input translation of the valve input shaft 704; the particular distance which point E, valve output shaft 706, and valve seat 708 translate apically is determined by the overall dimensions of compliant mechanism 702. In some embodiments, valve seat 708 may flex inwards—that is, fold into a V shape—to break a seal with the valve sidewall and allow fluid to flow through valve 700. In some embodiments, valve seat 708 may be rigid such that it displaces apically past a valve inlet (not pictured), thereby allowing fluid flow through valve 700. Alternatively, in some embodiments valve seat 708 may be rigid and valve 212 may further include and flexible disk 234 (not pictured) which operate in the same manner as described with respect to valve 212.

The double-nested design of compliant mechanism 702 further improves performance by distributing stress more evenly across the compliant mechanism 702 and the rhombus elements 702A, 702B thereof. This stress distribution may prevent localized wear or failure, thereby enhancing the longevity of the valve 700.

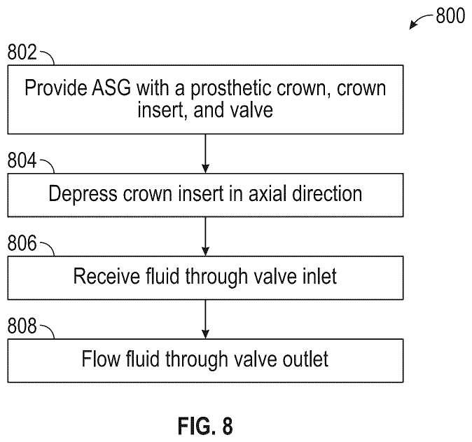

FIG. 8 depicts method 800 for pumping fluid. At 802, an ASG with a prosthetic crown, a crown insert, and a valve may be provided. In some embodiments, the prosthetic crown may define a crown orifice in which the crown insert is at least partially disposed. At 804, the crown insert may be depressed in an axial direction. In some embodiments, the axial direction may be an apical or coronal direction. At 806, a fluid is received through a valve inlet of the valve. In some embodiments, the fluid may be an interstitial fluid. At 808, the fluid may be flowed through the valve and further through the valve outlet of the valve. In some embodiments, flowing the fluid through the valve outlet may result in delivering the fluid to an oral cavity of the subject.

Interstitial fluid exists in bone at a slightly elevated pressure relative to venous pressure and its ionic content differs from that of saliva as seen in Table 1 below:

TABLE 1

| | |
|---|---|
| Interstitial Fluid | Saliva |

| | | | | |
|---|---|---|---|---|
| Cations | | | | |
| sodium | 136-145 | mmol/L | 2-26 | mmol/L |
| potassium | 3-4 | mmol/L | 13-40 | mmol/L |
| calcium | 1.2-5 | mmol/L | 0.5-2.8 | mmol/L |
| magnesium | 0.666 | mmol/L | 0.15-0.6 | mmol/L |
| Anions | | | | |
| chloride | 114 | mmol/L | 25 | mmol/L |
| phosphate | 0.61 | mmol/L | 6 | mmol/L |
| bicorbonate | 31 | mmol/L | 20 | mmol/L |
| sulphate | 1 | mmol/L | 1.45 | μmol/L |
| organic acid | 7 | mEq/L | | |

The disclosed systems and methods offer several advantages over currently available options, including:
1. Integration with existing dental implants: Unlike standalone artificial saliva devices such as the “artificial salivary gland” in U.S. Pat. No. 10,231,818, the systems and methods of the present disclosure are directly embedded within a dental implant, eliminating the need for additional attachments or procedures.
2. Reduced reliance on external products: Compared to over-the-counter rinses or prescription stimulants, the systems and methods of the present disclosure continually provide a saliva substitute via occlusal forces, minimizing the need for regular dosing or application.
3. Consistent fluid delivery: By actively pumping interstitial fluid on demand during normal biting, the systems and methods of the present disclosure offer more consistent relief than passive aids, such as mouth sprays, which only provide temporary moisture.
4. Integrated filtration mechanism: Unlike simpler implantable ducts or stents, the built-in filtration system of the systems and methods of the present disclosure remove cells and macromolecules, ensuring a cleaner fluid supply and reducing the risk of blockages.
5. Lower long-term maintenance costs: The cyclical pumping action of the systems and methods of the present disclosure require no batteries or external power, potentially lowering ongoing expenses compared to continuous-use mechanical pumps (e.g., external infusion devices) and repeated consumable purchases.
6. Minimally invasive activation: In contrast to surgical salivary gland transfers, the systems and methods of the present disclosure use natural bite force below 50N, reducing post-operative complexities and providing a less invasive method for alleviating xerostomia.

For reasons of completeness, various aspects of the disclosure are set out in the following numbered clauses:
Clause 1: A dental implant system including an artificial salivary gland assembly, wherein the artificial salivary gland assembly includes a housing, wherein the housing is configured and dimensioned to be at least partially disposed within a mouth of a subject; and an insert member at least partially disposed within the housing, the insert member including a pump, at least partially disposed therein; wherein the pump is configured and dimensioned to be driven, at least in part, by masticatory forces of the subject to harvest a fluid of the subject as a source for replacement saliva for the subject.

Clause 2: The artificial salivary gland assembly of clause 1, wherein the housing is configured and dimensioned to be at least partially implanted in a trabecular mandibular or maxillary bone of the subject.

Clause 3: The artificial salivary gland assembly of clause 2, wherein the housing utilizes interstitial fluid from a interstitial fluid reservoir within the mandibular or maxillary bone as the source for replacement saliva for the subject.

Clause 4: The artificial salivary gland assembly of clause 3, wherein the pump is driven, at least in part, by masticatory forces of the subject to harvest the interstitial fluid as the source for replacement saliva for the subject.

Clause 5: The artificial salivary gland assembly of clause 4, wherein the insert member includes treatment materials to adjust or alter the chemistry of the interstitial fluid.

Clause 6: The artificial salivary gland assembly of clause 5, wherein the treatment materials include ion-exchange resins.

Clause 7: The artificial salivary gland assembly of clause 5, wherein the treatment materials include mixed-bed ion-exchange resins and soluble particles.

Clause 8: The artificial salivary gland assembly of clause 1, wherein the pump is a piston pump, the piston pump being associated with a one-way valve.

Clause 9: The artificial salivary gland assembly of clause 5, wherein the pump utilizes the masticatory forces of the subject to power the pump to both harvest the interstitial fluid and drive interstitial fluid flow through the treatment materials to alter or adjust the chemistry of the interstitial fluid.

Clause 10: The artificial salivary gland assembly of clause 1, wherein the housing and the insert member include porous walls to capture the fluid.

Clause 11: The artificial salivary gland assembly of clause 1, wherein the housing is substantially hollow and the insert member is replaceable.

Clause 12: The artificial salivary gland assembly of clause 1, wherein the housing includes activated carbon disposed between the housing and the insert member.

Clause 13: The artificial salivary gland assembly of clause 1, further including an outer chamber in fluid flow contact with the insert member; and wherein when the subject chews, chewing forces due to the chewing of the subject pressurizes the outer chamber, thereby causing fluid flow through the insert member and out of an outlet of the insert member and into the mouth of the subject.

Clause 14: The artificial salivary gland assembly of clause 13, further including a valve member associated with the insert member; and wherein when the subject ceases chewing, the valve member associated with the insert member closes and creates a vacuum in the outer chamber, thereby drawing additional fluid into the outer chamber.

Clause 15: The artificial salivary gland assembly of clause 14, wherein the insert member includes one or more spring members; and wherein when the user ceases chewing, the one or more spring members facilitate the closing of the valve member.

Clause 16: The artificial salivary gland assembly of clause 15, wherein the valve member is a one-way valve.

Clause 17: The artificial salivary gland assembly of clause 15, wherein the one or more spring members are spiral stainless steel spring members.

Clause 18: The artificial salivary gland assembly of clause 1, wherein the housing is a porous osseointegrated shell.

Clause 19: The artificial salivary gland assembly of clause 1, wherein the insert member screws or snap fits into the housing.

Clause 20: The artificial salivary gland assembly of clause 1, wherein the pump has an active surface area of about 267 mm².

Clause 21: The artificial salivary gland assembly of clause 1, wherein a ring pump design with a pump volume displacement of 7.2 mm³ at a vertical displacement of 0.2 mm (yielding −80 MPa vacuum).

Clause 22: The artificial salivary gland assembly of clause 21, wherein the ring would be driven with occlusal pressure opposed by a stainless steel spiral spring.

Clause 23: The artificial salivary gland assembly of clause 1, wherein the assembly restores normal saliva flow, along with important salivary functions, especially anti-caries, and saliva-like fluid can flow at a constant background rate during rest and at a higher rate during eating.

Clause 24: The artificial salivary gland assembly of clause 1, wherein the assembly can also be utilized to introduce beneficial bacteria into the oral cavity and/or be utilized as a delivery system for drugs/therapeutic agents.

Clause 25: The artificial salivary gland assembly of clause 1, wherein mechanical pumping of interstitial fluid is achieved via a moveable poppet check valve located within the core of the implant.

Clause 26: The artificial salivary gland assembly of clause 1, wherein occlusal forces translate to apical depression of the valve, and the flexible nature of the disk allows the valve to pass down the length of the internal cartridge and through interstitial fluid with minimal resistance.

Clause 27: The artificial salivary gland assembly of clause 1, wherein the assembly includes an internal cartridge with tight-fitting walls, wherein the tight-fitting walls of the internal cartridge maintain the interstitial fluid in the internal cartridge compartment and act as an external seal for the moveable valve.

Clause 28: The artificial salivary gland assembly of clause 1, wherein once the biting force is removed, the spring decompresses and reverses the direction of the valve to drive the unit occlusally, thus pressing the flexible disk against the seat and sealing off the backflow.

Clause 29: The artificial salivary gland assembly of clause 1, wherein the cartridge is sealed by the flexible disk and with the space between the seat, the valve provides a vertical occlusal force to pump the interstitial fluid above it through a series of gingival margin-level fluid outlets and into the oral cavity.

Clause 30: The artificial salivary gland assembly of clause 1, wherein the tight seal between the flexible disk, the seat, and the inside walls of the internal cartridge creates a negative pressure to draw up fluid from the marrow space and into the implant.

Clause 31: The artificial salivary gland assembly of clause 1, wherein as the interstitial fluid enters the implant it moves through a polypropylene membrane filter that excludes marrow cells and macromolecules.

Clause 32: The artificial salivary gland assembly of clause 1, wherein an optional second filter and antibacterial coatings exclude bacterial infiltration into the implant.

Clause 33: The artificial salivary gland assembly of clause 32, wherein the cycle repeats with recurrent occlusal forces such as from chewing and ultimately unidirectionally pumps interstitial fluid from within the marrow space of alveolar bone into the mouth.

Clause 34: The artificial salivary gland assembly of clause 1, wherein to pump a clinically relevant volume of fluid (i.e. about 0.01 to 0.02 mL per stroke) the assembly utilizes a displacement amplifier that converts small displacements (tenths of millimeters) at the occlusal surface to millimeters of displacement of the central shaft.

Clause 35: The artificial salivary gland assembly of clause 34, wherein the displacement amplifier comprises a sealed chamber with several O-rings. Loads generated during tooth contact (about 50 N) hydraulically pressurize this displacement amplifier, causing apical motion of the shaft and valve sufficient to drive the fluid pump.

Clause 36: The artificial salivary gland assembly of clause 1 including an internal cartridge and a poppet check valve.

Clause 37: The artificial salivary gland assembly of clause 1, wherein the subject is a mammal.

Clause 38: The artificial salivary gland assembly of clause 37, wherein the mammal is human.

Clause 39: A method to use a dental implant system including an artificial salivary gland device of any one of clauses 1-39.

Clause 40: A method for harvesting fluid including: disposing an implant member within a mouth of a subject; disposing an insert member at least partially within the implant member; and capturing and harvesting existing fluid of the subject as replacement saliva to the subject via the implant member and the insert member; wherein the fluid is interstitial fluid or marrow fluid.

Clause 41: The method of clause 40, wherein the implant member that is configured and dimensioned to be at least partially implanted in mandibular or maxillary bone of the subject; and wherein the implant member and the insert member utilize fluid from within the mandibular or maxillary bone as the replacement saliva for the subject.

Clause 42: The method of clause 40, wherein the implant member and the insert member include porous walls to harvest the fluid; and wherein the insert member is configured to screw or snap fit into the implant member.

Clause 43: The method of clause 40, wherein the insert member includes a piston member, the piston member configured to be driven, at least in part, by tooth contact forces of the subject to harvest the fluid as the replacement saliva for the subject.

Clause 44: The method of clause 43, wherein the piston member is driven, at least in part, by masticatory forces or incidental tooth contact during swallowing forces of the subject on the piston member to harvest the fluid as the replacement saliva for the subject.

Clause 45: The method of clause 40, wherein the insert member includes treatment materials to adjust or alter the chemistry of the fluid; and wherein the treatment materials include semi-permeable membranes or soluble particles.

Clause 46: The method of clause 43, wherein the piston member is a piston head; and wherein the piston head is in fluid communication with a one-way valve.

Clause 47: The method of clause 43, wherein the piston member utilizes the tooth contact forces of the subject to: (i) harvest the fluid, (ii) drive the fluid to flow through treatment materials to alter or adjust the chemistry of the fluid, and (iii) drive the fluid to an oral cavity of the subject.

Clause 48: The method of clause 40, wherein the implant member is substantially hollow and the insert member is removable and replaceable from the implant member.

Clause 49: The method of clause 40, wherein the insert member includes an outer chamber in fluid communication with the fluid; and wherein when tooth contact forces of the subject engage the insert member, the outer chamber is pressurized, thereby causing fluid to flow through the insert member and out of an outlet of the insert member and into an oral cavity of the subject.

Clause 50: The method of clause 49, further including a valve member associated with the insert member; and wherein when the tooth contact forces cease engaging the insert member, the valve member closes and creates a vacuum in the outer chamber, thereby drawing additional fluid of the subject into the outer chamber.

Clause 51: The method of clause 50, wherein the insert member includes one or more spring members; and wherein when the tooth contact forces cease engaging the insert member, the one or more spring members facilitate the closing of the valve member.

Clause 52: The method of clause 40, further including a crown member mounted with respect to the insert member, the crown member providing a coronal chewing surface for the subject, and providing a chamber configured to house or treat the fluid.

Clause 53: The method of clause 40, wherein the insert member includes a fluidically-driven piston member in communication with a fluid bladder member of a crown member, the fluid bladder member having an occlusal member mounted on a coronal end of the fluid bladder member; and wherein the fluidically-driven piston member is configured to be driven, at least in part, by tooth contact forces of the subject on the occlusal member to harvest the fluid as the replacement saliva for the subject.

Clause 54: The method of clause 40, further including a filter member mounted to an apical end of the insert member, wherein the filter member is in communication with a fluid reservoir of the implant member.

Clause 55: The method of clause 40, further including an abutment member, the abutment member configured to be at least partially disposed within the implant member, with the insert member configured to be at least partially disposed within the abutment member and at least partially disposed within the implant member to secure the abutment member, the insert member and the implant member to one another.

Clause 56: The method of clause 40, further including a crown member mounted on a coronal end of the abutment member, and a piston member mounted on a coronal end of the insert member, the piston member configured to be driven, at least in part, by tooth contact forces of the subject to harvest the fluid as the replacement saliva for the subject.

Clause 57: The method of clause 40, wherein the insert member is threadably engaged with the implant member to secure the abutment member, the insert member and the implant member to one another.

Clause 58: A dental implant assembly/system including: an implant member, the implant member configured and dimensioned to be at least partially disposed within a mouth of a subject; and an insert member at least partially disposed within the implant member; wherein the implant member and the insert member are configured and dimensioned to capture and harvest existing fluid of the subject as replacement saliva to the subject; and wherein the fluid is interstitial fluid or marrow fluid.

Clause 59: The dental implant assembly/system of clause 58, wherein the implant member is configured and dimensioned to be at least partially implanted in mandibular or maxillary bone of the subject; and wherein the implant member and the insert member utilize fluid from within the mandibular or maxillary bone as the replacement saliva for the subject.

Clause 60: The systems/assemblies and methods of clauses 1-59, wherein the subject is a mammal.

Clause 61: The systems/assemblies and methods of clause 60, wherein the mammal is human.

Clause 62: An artificial salivary gland for providing fluid to an inside of a subject's mouth, the artificial salivary gland including: a prosthetic crown that includes a crown bottom portion; an implant fixture that defines a top portion, a bottom portion, a fixture inlet, and a fixture outlet, wherein: the implant fixture defines an internal bore; and the top portion of the implant fixture is disposed proximate the crown bottom portion; and a valve disposed at least partially within the internal bore of the implant fixture, the valve including a valve inlet and a valve outlet; wherein the fixture inlet is in fluid communication with the valve inlet, the valve inlet is in fluid communication with the valve outlet, and the valve outlet is in fluid communication with the fixture outlet.

Clause 63: The artificial salivary gland of clause 62, wherein: the valve further includes a coil spring and a valve shaft; the coil spring includes a spring bottom end and a spring top end; the valve shaft includes a shaft bottom end and a shaft top end; and the spring top end is disposed adjacent the shaft bottom end.

Clause 64: The artificial salivary gland of clause 62, further including a crown insert, wherein: the prosthetic crown defines a crown orifice; the crown insert is disposed at least partially within the crown orifice; and depressing the crown insert in an axial direction causes a valve shaft of the valve to translate in the axial direction.

Clause 65: The artificial salivary gland of clause 62, further including a crown insert which defines an insert surface, wherein: the prosthetic crown defines a crown orifice and a crown surface; the crown insert is disposed at least partially within the crown orifice; and depressing the crown insert in an axial direction causes the crown surface and the insert surface to jointly and continuously define an occlusal surface which is substantially continuous.

Clause 66: The artificial salivary gland of clause 62, wherein the occlusal surface of the artificial salivary gland mimics an occlusal surface of a crown of a natural tooth.

Clause 67: The artificial salivary gland of clause 62, further including a displacement amplifier.

Clause 68: The artificial salivary gland of clause 62, further including a filter capable of removing at least one of marrow cells and macromolecules from interstitial fluid.

Clause 69: The artificial salivary gland of clause 68, wherein the filter is disposed between the fixture inlet and the valve inlet.

Clause 70: The artificial salivary gland of clause 68, wherein the filter is disposed coronally of the valve inlet.

Clause 71: The artificial salivary gland of clause 68, wherein the filter includes a polypropylene membrane.

Clause 72: The artificial salivary gland of clause 62, wherein the implant fixture further includes a sidewall, and wherein an outer surface of the implant fixture is threaded.

Clause 73: The artificial salivary gland of clause 62, wherein the implant fixture includes an osseointegratable material.

Clause 74: The artificial salivary gland of clause 62, wherein the implant fixture further includes a fixture chamber disposed proximate the bottom portion, wherein the fixture inlet is defined by a sidewall of the fixture chamber.

Clause 75: The artificial salivary gland of clause 62, wherein the fixture outlet of the implant fixture is defined by a sidewall of the implant fixture.

Clause 76: The artificial salivary gland of clause 62, wherein the implant fixture is configured such that, when installed in a jawbone of the subject, the fixture outlet is in fluid communication with an oral cavity of the subject.

Clause 77: A method for pumping fluid, the method including: providing an artificial salivary gland that includes: a prosthetic crown defining a crown orifice; a crown insert disposed at least partially within a crown orifice; and a valve; depressing the crown insert in an axial direction; receiving, through a valve inlet of the valve, the fluid; flowing the fluid through a valve outlet of the valve.

Clause 78: The method of clause 77, further including filtering the fluid prior to flowing the fluid through the valve outlet.

Clause 79: The method of clause 77, further including removing at least one of marrow cells and macromolecules from the fluid.

Clause 80: The method of clause 77, further including forming an occlusal surface on at least one of a top portion of the prosthetic crown and the crown insert.

Clause 81: The method of clause 77 further including delivering the fluid to an oral cavity of a subject.

Clause 82: The systems/assemblies and methods of clauses 62-81, wherein the subject is a mammal.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. An artificial salivary gland for providing fluid to an inside of a subject's mouth, the artificial salivary gland comprising:
a prosthetic crown comprising a crown bottom portion;
an implant fixture comprising a top portion, a bottom portion, a fixture inlet, and a fixture outlet, wherein:
the implant fixture defines an internal bore; and
the top portion of the implant fixture is disposed proximate the crown bottom portion; and
a valve disposed at least partially within the internal bore of the implant fixture, the valve comprising a valve inlet and a valve outlet; wherein
the fixture inlet is in fluid communication with the valve inlet, the valve inlet is in fluid communication with the valve outlet, and the valve outlet is in fluid communication with the fixture outlet.

2. The artificial salivary gland of claim 1, wherein:
the valve further comprises a coil spring and a valve shaft;
the coil spring comprises a spring bottom end and a spring top end;
the valve shaft comprises a shaft bottom end and a shaft top end; and
the spring top end is disposed adjacent the shaft bottom end.

3. The artificial salivary gland of claim 1, further comprising a crown insert, wherein:
the prosthetic crown defines a crown orifice;
the crown insert is disposed at least partially within the crown orifice; and
depressing the crown insert in an axial direction causes a valve shaft of the valve to translate in the axial direction.

4. The artificial salivary gland of claim 1, further comprising a crown insert which defines an insert surface, wherein:
the prosthetic crown defines a crown orifice and a crown surface;
the crown insert is disposed at least partially within the crown orifice; and
depressing the crown insert in an axial direction causes the crown surface and the insert surface to jointly and continuously define an occlusal surface which is substantially continuous.

5. The artificial salivary gland of claim 4, wherein the occlusal surface of the artificial salivary gland mimics an occlusal surface of a crown of a natural tooth.

6. The artificial salivary gland of claim 1, further comprising a displacement amplifier.

7. The artificial salivary gland of claim 1, further comprising a filter capable of removing at least one of marrow cells and macromolecules from interstitial fluid.

8. The artificial salivary gland of claim 7, wherein the filter is disposed between the fixture inlet and the valve inlet.

9. The artificial salivary gland of claim 7, wherein the filter is disposed coronally of the valve inlet.

10. The artificial salivary gland of claim 7, wherein the filter comprises a polypropylene membrane.

11. The artificial salivary gland of claim 1, wherein the implant fixture further comprises a sidewall, and wherein an outer surface of the implant fixture is threaded.

12. The artificial salivary gland of claim 1, wherein the implant fixture comprises an osseointegratable material.

13. The artificial salivary gland of claim 1, wherein the implant fixture further comprises a fixture chamber disposed proximate the bottom portion, wherein the fixture inlet is defined by a sidewall of the fixture chamber.

14. The artificial salivary gland of claim 1, wherein the fixture outlet of the implant fixture is defined by a sidewall of the implant fixture.

15. The artificial salivary gland of claim 1, wherein the implant fixture is configured such that, when installed in a jawbone of the subject, the fixture outlet is in fluid communication with an oral cavity of the subject.

16. A method for pumping fluid, the method comprising:
providing an artificial salivary gland comprising:
a prosthetic crown defining a crown orifice;
a crown insert disposed at least partially within a crown orifice; and
a valve;
depressing the crown insert in an axial direction;
receiving, through a valve inlet of the valve, the fluid;
flowing the fluid through a valve outlet of the valve.

17. The method of claim 16, further comprising filtering the fluid prior to flowing the fluid through the valve outlet.

18. The method of claim 16, further comprising removing at least one of marrow cells and macromolecules from the fluid.

19. The method of claim 16, further comprising forming an occlusal surface on at least one of a top portion of the prosthetic crown and the crown insert.

20. The method of claim 16, further comprising delivering the fluid to an oral cavity of a subject.
